(19) United States
(12) Patent Application Publication
(10) Pub. No.: US 2009/0307189 A1
(43) Pub. Date: Dec. 10, 2009

(54) ASYNCHRONOUS WORKFLOW PARTICIPATION WITHIN AN IMMERSIVE COLLABORATION ENVIRONMENT

(75) Inventors: Lisa Louise Bobbitt, Cary, NC (US); Gregory Dean Pelton, Raleigh, NC (US); William Henry Morrison, IV, Cary, NC (US); James Jerome Miner, Morrisville, NC (US); Jonathan Gregory Rossie, JR., Holly Springs, NC (US); Douglas Jay Walker, Raleigh, NC (US)

Correspondence Address: SCHWEGMAN, LUNDBERG & WOESSNER, P.A., P.O. BOX 2938, MINNEAPOLIS, MN, 55402, US

(73) Assignee: CISCO TECHNOLOGY, INC., San Jose, CA (US)

(21) Appl. No.: 12/133,226

(22) Filed: Jun. 4, 2008

(51) Int. Cl. G06F 7/06; G06F 17/30

(52) U.S. Cl. 707/3; 707/101; 707/E17.014; 707/E17.044

(57) ABSTRACT

A system (and corresponding method) that enables establishment of a record associated with an immersive collaborative environment is provided. The record represents events and actions that occur within the virtual environment. Additionally, the system enables a user to modify the record following the initial capture. Upon modification, the record is ‘time-shifted’ such that the resultant record is a seamless chronological rendition of events and actions that occurred within the immersive collaborative environment or virtual workspace.

### BACKGROUND

Virtual Reality (VR) refers to a technology which allows a user to interact within a computer-simulated environment. Generally, this computer-simulated environment can relate to a real or imagined scenario. Current VR environments are primarily visual experiences which are displayed either via a monitor or through specialized stereoscopic displays (e.g., goggles). In addition to visual effects, some simulations include additional sensory information, for example, audible or vibratory sensations. More advanced, ‘haptic’ systems now include tactile information, generally known as ‘force feedback,’ in many gaming applications.

Today, users most often interact with a VR environment by way of standard input devices such as a keyboard, mouse, joystick, trackball or other navigational device. As well, multimodal devices such as a specialized haptic wired glove are used to interact with and within the VR environment.

Recent developments in VR have been directed to three-dimensional (3D) gaming environments. Generally, a ‘virtual world’ is a computer-based simulated environment intended for its users to inhabit and interact via avatars. An ‘avatar’ refers to a representation of a user usually employed by way of the Internet to depict a user. An avatar can be a 3D model used in computer games, a two-dimensional image (e.g., icon) used within Internet and other community forums (e.g., chat rooms) as well as text constructs usually found on early systems. Thus, presence within the 3D virtual world is most often represented in the form of two or 3D graphical representations of users (or other graphical or text-based avatars).

Today, nature and technology are equally integrated into 3D virtual worlds in order to enhance the reality of the environment. For example, actual topology, gravity, weather, actions and communications are able to be expressed within these virtual worlds thereby enhancing the reality of the user experience. Although early virtual world systems employed text as the means of communication, today, real-time audio (e.g., voice-over-Internet Protocol (VoIP)) is most often used to enhance communications.

Although the technological advances in graphics and communications have vastly improved the quality of the virtual worlds, these virtual environments have been centered around the gaming industry. As such, users control actions and the system is preprogrammed with responses to those actions.

Somewhat similar to VR, ‘Augmented Reality’ (AR) most often relates to a field of computer research that describes the combination of real world and computer generated data. Conventionally, AR employs with the use of video imagery which is digitally processed and ‘augmented’ with the addition of computer-generated graphics. As with VR, traditional uses of AR have been primarily focused around the gaming industry.

Most often, conventional AR systems employed specially-designed translucent goggles. These goggles enable a user to see the real world as well as computer-generated images projected atop of the real world vision. These systems attempt to combine real world vision with a virtual world. Unfortunately, traditional systems fall short in their ability to leverage the vast amount of information and data now available to users. Additionally, traditional systems are time sensitive such that a user must participate in the real-time session in order to experience and/or benefit from the virtual environment.

### BRIEF DESCRIPTION OF THE DRAWINGS

FIG. 1 illustrates an example asynchronous participation management system that facilitates asynchronous participation in accordance with an aspect of the specification.

FIG. 2A illustrates an example flow chart of procedures that facilitate establishment of a record related to events and activities within an immersive collaborative environment in accordance with an aspect of the disclosure.

FIG. 2B illustrates an example flow chart of procedures that facilitate asynchronous or subsequent participation in accordance with an aspect of the disclosure.

FIG. 3 illustrates a block diagram of a high-level component system that facilitates immersive collaboration in accordance with embodiments of the specification.

FIG. 4 illustrates an alternative block diagram of an asynchronous participation management component that employs record generation and record management components to facilitate subsequent participation in accordance with aspects of the specification.

FIG. 5 illustrates an example block diagram of a monitor component that establishes content, contacts and context analysis in accordance with aspects of the disclosure.

FIG. 6 illustrates an example capture component that facilitates generation of a time-based historical record in accordance with an aspect of the specification.

FIG. 7 illustrates an example system that employs a search component and a record modification component to effect asynchronous participation in accordance with an embodiment of the specification.

FIG. 8 illustrates an example search component that enables location and playback of a time-based historical record associated with a virtual workspace in accordance with the specification.

FIG. 9 illustrates an example record modification component that enables update, notification and decision modification in accordance with aspects of the disclosure.

FIG. 10 illustrates a block diagram of a computer operable to execute the disclosed architecture.

FIG. 11 illustrates a schematic block diagram of an exemplary computing environment in accordance with the subject specification.

### DESCRIPTION

### Overview

The following presents a simplified overview of the specification in order to provide a basic understanding of some example aspects of the specification. This overview is not an extensive overview of the specification. It is not intended to identify key/critical elements of the specification or to delineate the scope of the disclosure. Its sole purpose is to present some concepts of the specification in a simplified form as a prelude to the more detailed description that is presented later.

This specification discloses appropriate technology and processes to create the paradigm shift that moves real-life enterprises into the immersive world that was traditionally reserved for three-dimensional (3D) gaming technologies. Essentially, integrated data in an immersive collaboration environment can provide for activating changes in behaviors of persons—awareness is critical to efficiency and productivity. More particularly, the aspects described herein provide for an ability to capture a time-based historical record of activities and actions that occur within a virtual workspace. As well, the specification describes mechanisms and components that enable asynchronous participation upon playback of the time-based historical record.

The concepts disclosed and claimed herein, in one aspect thereof, comprise a system (and corresponding method) that relates to scenarios where a user (or their avatar) misses a meeting but would like to inject additional information (or their viewpoint) into the record. Effectively, a user can asynchronously visit (or re-visit) the meeting via a playback and thereafter inject information and/or data into the content of the meeting.

Similar to a blog, a time-based historical record can be constructed of layered information. In accordance with aspects, a user can generate information which is appended to the end of a meeting as well as inject data within the content so as to correct or otherwise edit information. Thereafter, playback of the record can include the modified portion in a chronologically accurate manner. This modified portion can be seamlessly inserted or, if desired, can be marked (or tagged) as modified data. Effectively, the innovation enables a user to modify a project at a later time, which enables simulation of different outcomes based upon specific modifications.

To the accomplishment of the foregoing and related ends, certain illustrative aspects of the specification are described herein in connection with the following description and the annexed drawings. These aspects are indicative, however, of but a few of the various ways in which the principles of the specification can be employed and the subject specification is intended to include all such aspects and their equivalents. Other advantages and novel features of the specification will become apparent from the following detailed description of the specification when considered in conjunction with the drawings.

### BRIEF DESCRIPTION OF EXAMPLE EMBODIMENTS

The specification is now described with reference to the drawings, wherein like reference numerals are used to refer to like elements throughout. In the following description, for purposes of explanation, numerous specific details are set forth in order to provide a thorough understanding of the subject specification. It may be evident, however, that the specification can be practiced without these specific details. In other instances, well-known structures and devices are shown in block diagram form in order to facilitate describing the specification.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

‘Virtual Reality’ (VR) environments are often referred to as ‘immersive environments.’ However, conventional immersive environments often lack an implication that ‘reality’ is being simulated within a digital space. In accordance with embodiments of the specification, an immersive environment can be a model of reality, as well as a complete fantasy user interface (UI) abstraction where the user of the environment is virtually immersed within it. Essentially, the term ‘immersion’ suggests that a user experiences a presence within the virtual environment. The success with which an immersive environment can actually immerse a user is dependent on many factors such as believable graphics (two-dimensional (2D), two & a half-dimensional (2½ D) and three-dimensional (3D)), sound, interactive user engagement, among others.

Conventionally, immersive environments are currently used for multiplayer gaming where they offer a set of communication services along with gameplay and character development. Within these virtual worlds, people are represented as avatars and they must collaborate to achieve tasks. The subject specification provides mechanisms to enable a record to be prepared which memorializes events and actions from a virtual workspace. Additionally, the specification describes mechanisms that provide version control for temporal data (e.g., the record). In other words, the disclosure describes mechanisms whereby a chronological record can be manipulated at a later date resulting in a seamless chronologically accurate record of a virtual workspace.

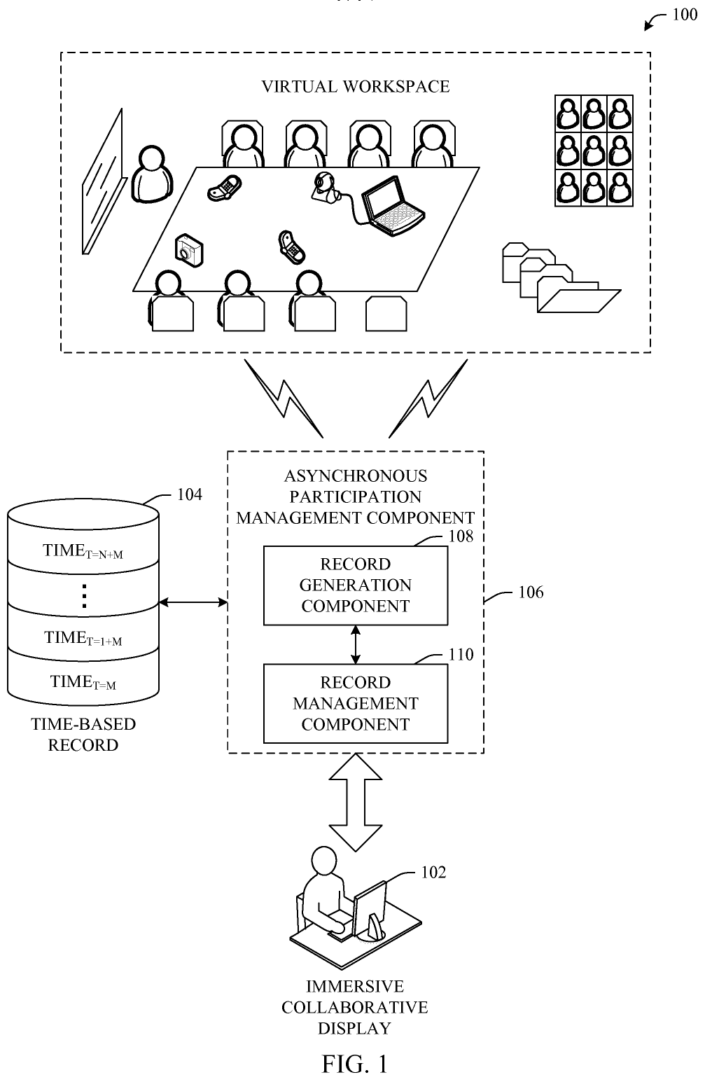

Referring initially to FIG. 1, the figure illustrates a system 100 that enables a user to asynchronously view and otherwise modify actions that take place within a virtual workspace. This playback and/or modification can be effected via an immersive collaborative display 102 as shown. While conventional systems required proactive real-time collaboration by users, the subject specification describes and discloses a system 100 which can establish a time-record 104 of activities and actions within a virtual workspace. This time-based record can be manipulated at a later point in time.

Generally, system 100 can include an asynchronous participation management component 106 that facilitates generation and management of a time-based record associated with a virtual workspace. It is to be understood that ‘asynchronous’ is used herein to refer to a situation other than real-time. For instance, in one aspect, asynchronous participation can be effected after conclusion of a meeting or activity within a virtual workspace. Similarly, most any time delay can be seen as asynchronous participation such that other users (or their avatars) are not actively participating with the user (or group of users) who is asynchronously participating in the virtual workspace.

One useful feature of the innovation is that it allows a user to participate in a virtual conference, workflow or meeting in an off-line manner. For example, a user can download or synchronize the time-based record 104 onto a local device (e.g., laptop computer, mobile phone, personal digital assistance (PDA), personal media player, and thereafter participate in an asynchronous manner. One scenario where this would be useful is where a Wi-Fi or other Internet or network connection is not available (e.g., on an airplane). Here, although the user was not available to participate during the virtual meeting, playback and modification/interjection of data/information can be effected at a later time. As will be understood upon a review of the disclosure that follows, this modification/interjection can be used merely to amend the record or alternatively, can be taken into account to re-adjust (either manually or automatically) decisions or outcomes of the meeting. For instance, upon receiving a user's modification/interjections, all participants can be notified by the system in order to give them an opportunity to comment or otherwise modify their previous input. Effectively, the meeting becomes a process that can span a period of time in order to enable and otherwise enhance participation.

As illustrated, the asynchronous participation management component 106 can include a record generation component 108 and a record management component 110 that facilitate generation and management of the time-based record 104 respectively. The time-based record 104 can be organized or formatted in a manner consistent with the types of data captured from the virtual workspace. Essentially, all aspects of the virtual workspace can be captured and incorporated into the time-based record 104. For instance, data including, but not limited to, text, audio, video, files, sources, contacts, discussions, etc. can be maintained in a chronological format within the time-based record 104.

The time-based record 104 can be structured in an ‘onion’ or blog-type manner such that later events are stacked upon the earlier events (or vice-versa). In other words, in order to review the record of a virtual workflow, a user can drill down from the most recent time (e.g., TIME_{T=N+M}) to the earliest time within the record (e.g., TIME_{T=M}). Also, as used herein, a ‘time-based record’ or ‘time-based historical record’ (e.g., 104) refers to a sequential data set that can include text, audio, video, user comments, records of consensus and other data and events that document collaborative discussion with a virtual workspace environment.

In operation, the record generation component 108 can monitor actions, discussions, data accesses, etc. that take place within a virtual workspace and can thereafter establish a record of the events or workflow processes that take place. In other words, the time-based record 104 can be constructed of a compilation of relevant or otherwise associated items from the immersive collaborative space. As will be understood upon a review of the figures that follow, events that occur within the virtual workspace can be tagged and indexed based upon most any factor including, but not limited to, content, contacts and context associated with each event or groups of events. For instance, in one aspect, each sub-process within a workflow can be tagged and indexed based upon the subject of the event, who participated in the event, when the event occurred, what decision (if any) was made during the event, etc. In other words, most any factor associated with the event can be used to tag or otherwise index an event within the time-based record 104.

The record management component 110 enables a user to search and view all, or some portion, of the time-based record 104. Additionally, as appropriate, the user can modify, update, or add content to the record. In some aspects, this modification to the content of the record can be used to infer or otherwise modify an outcome or decision made within the collaborative environment. For example, as additional information is interjected into the record, this information can be used to revisit and potentially revise the record based upon the modified or new data. As will be understood upon a review of the figures that follow, once a user modifies the record, a notification can be sent to each of the other participants in the event so as to afford them an opportunity to review the new or modified information. As well, this notification will enable users to modify their outcome, decision or consensus in accordance with the new information.

While many of the aspects and embodiments described herein are directed to business or enterprise workflows, it is to be understood that most any activity- or subject-based activity/action can effected by way of an immersive collaborative display. Thus, a time-based record can be established and asynchronous participation can be enabled. These alternative aspects are to be included within the scope of the innovation and claims appended hereto.

As shown in FIG. 1, it is to be understood that the virtual workspace can be representative of most any workflow, action, activity event or group of events. In a specific example, an immersive virtual world can be designed to represent a business or enterprise environment. While there are many possible metaphors that could be used to describe the display, one manner in which to describe the display is a collection of ‘rooms’ or ‘spaces.’ It is to be understood that, in aspects, spaces or rooms can be representative of buildings, theme-based rooms (e.g., office, lobby, living room), landscapes or other visual representations. In some examples, users are represented in the world as avatars that occupy the spaces or rooms. It is to be understood that the rooms can be geographically and/or visually distinct from each other. For example, each room can represent a particular business context—e.g., construct that is representative of something from the business domain. For instance a room might represent an office, a department, a project, a process, an organization, a work product, a task, etc.

Ultimately, the geography and structure of the world rendered captures elements of the context (e.g., business context) it is supporting. Effectively, the user (or groups of users) can be depicted in the display as performing business tasks while in the virtual world. These tasks may include such tasks as working on specific documents, attending meetings or collaborating with others. The tasks may be directly supported by the virtual world or may be in adjacent workspaces.

As the user performs a task, the geography or special representation in the virtual world can adjust and reconfigure itself to provide context specific assistance to the user. One illustration of this would be a user writing a document about a product design. Here, as the user types or scrolls through the document, they could see new pictures hanging on the wall of their virtual room that represent prevalent themes in the document. Additionally, they may also be presented with objects on the floor that represent common reference material like a dictionary, a design process document, etc. Other documents related to the product, schematics, etc. may appear as files on a virtual table or presentation screen.

It is to be understood and appreciated that there are a multiplicity of different potential representations that support the visual metaphor of the virtual world and rooms. As such, these multiplicities of different representations are to be included within the scope of the specification and claims appended hereto. One feature of the system is that the environment representation can reflect relevance to the user's current activity, and state or context within that activity. As well, the system can enable representation of the task or activity to adapt (in (or near) real-time) as the task (or context within the task) of the user changes. Still further, the system is capable of anticipating or inferring context of the user, thereby supporting efforts by providing relevant resources to the user.

While the aforementioned discussion provides an overview perspective of a virtual world or immersive collaborative environment, the subject specification discloses mechanisms by which a time-based record of events and activities within the environment can be captured. Further, the subject disclosure presents mechanisms that enable users to view (or playback) events or activities from the captured record. Still further, the subject concepts enable users to asynchronously modify the record of the meeting, workflow, activity, events, etc. Other features, functions and benefits of the subject specification are described with reference to the figures that follow.

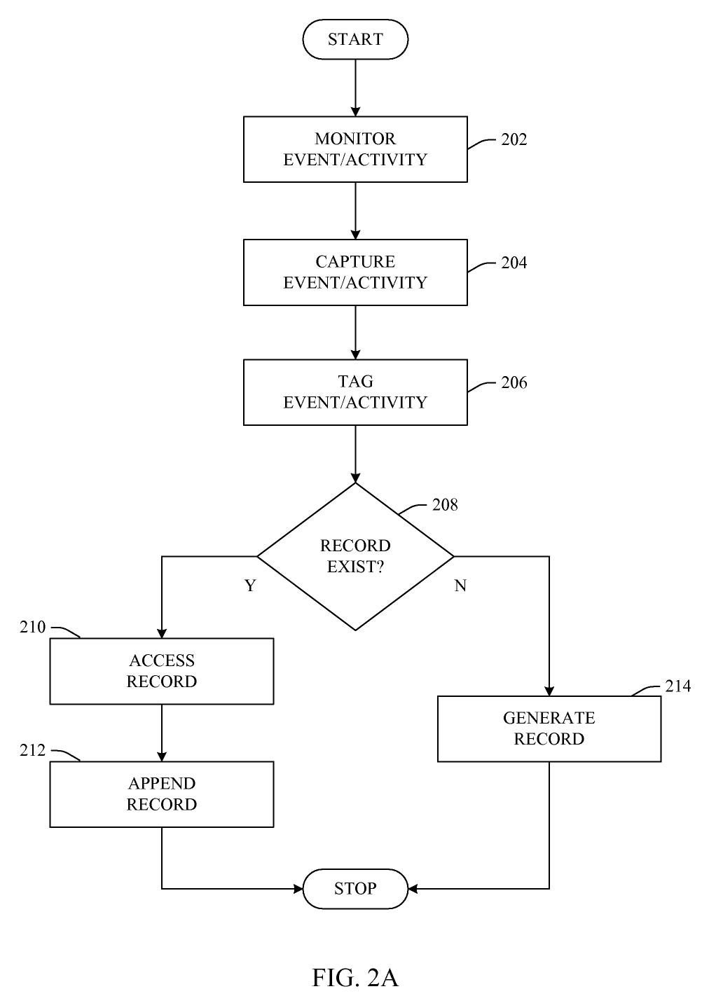

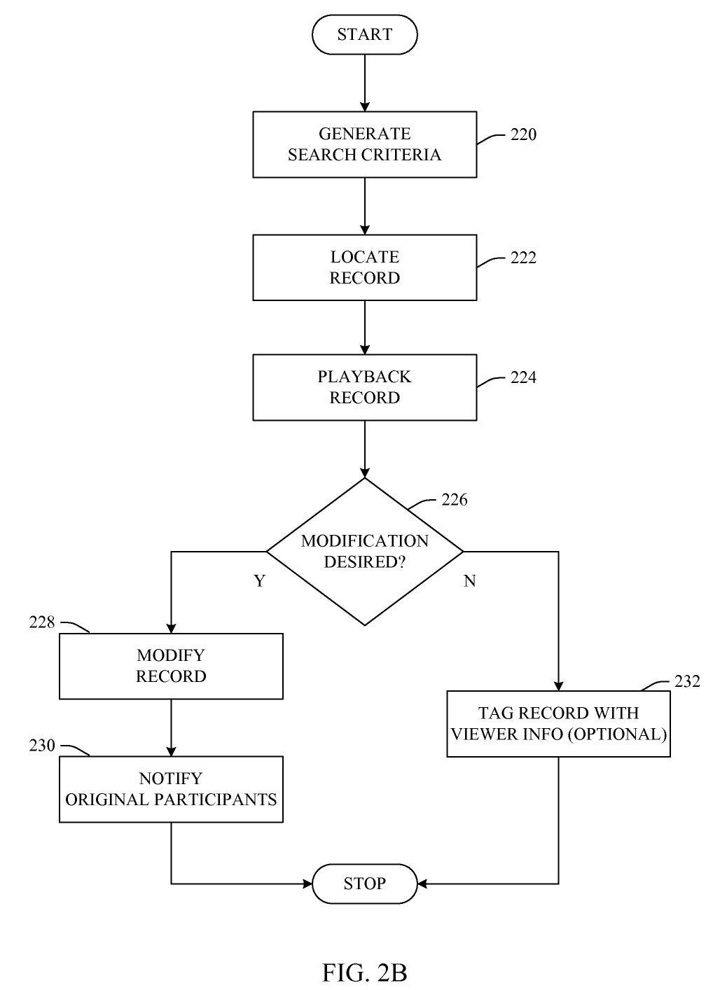

FIGS. 2A and 2B illustrate example methodologies of establishing a record of events/activities and modifying the record respectively in accordance with an aspect of the specification. Generally, the methodology of FIG. 2A enables establishment of a record that corresponds to events and activities related to a workflow, project, etc. within a virtual workspace. Once a record is established, the methodology of FIG. 2B facilitates playback as well as asynchronous modification of the record so as to enable a user to asynchronously participate in a session at a later point in time.

While, for purposes of simplicity of explanation, the one or more methodologies shown herein, e.g., in the form of a flow chart, are shown and described as a series of acts, it is to be understood and appreciated that the subject specification is not limited by the order of acts, as some acts may, in accordance with the specification, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the specification

Referring first to FIG. 2A, activities and events within a virtual workspace or immersive collaborative environment are monitored at 202. For example, content, actions, data accesses, individual's presence, conversations, consensus discussed/reached, context, etc. can be monitored. As will be understood, the granularity of the monitoring is user definable or defined by the system automatically on behalf of a user. Most any factor, parameter or criteria can be employed to monitor the workspace or environment.

Accordingly, at 204, information from the workspace or environment is captured. For example, the factors that are monitored can be captured and prepared for storage in most any format, including but not limited to, video, audio, text, etc. Similar to monitoring at 202, the granularity of information captured at 204 can be predefined by a user (or enterprise) as well as inferred by the system on behalf of a user, e.g., via machine learning and reasoning (MLR) mechanisms.

At 206, the captured information can be tagged or otherwise prepared for indexing and storage. As will be appreciated, most any tagging scheme can be employed to accomplish a comprehensive storage/retrieval mechanism. In one aspect, a record can be established merely based upon time, however, most any other descriptive criteria can be employed to enhance the comprehensiveness of the data.

A determination is made at 208 to establish if a record exists. In other words, suppose a meeting is commenced on one day and a record is established. Subsequently, on the next day, the meeting continued—here, a conclusion can be made that a record associated to a particular meeting (activity, event, etc.) exists. Thus, at 210, the record can be accessed, for example, from a store and thereafter appended.

Alternatively, if a record does not exist at 208, a new record can be established at 214. Essentially, in accordance with the methodology of FIG. 2A, a time-based record of events and/or activities that occur within a virtual workspace or immersive collaborative environment is established. Portions within the record can be tagged or otherwise identified based upon most any scheme or preference as desired. Similarly, the information within the record can be indexed based upon most any criteria, including but not limited to, content, contacts, context, consensus, etc. As will be described with regard to FIG. 2B, the record can be used to share the captured information with users who could not or did not attend the original session. Additionally, the specification describes mechanisms by which a user can asynchronously modify the record by retrieving and reviewing all, or a portion, of the captured record.

Turning now to FIG. 2B, illustrated is an example methodology that facilitates location, review and/or modification of a record as appropriate. Essentially, at 220, search criteria can be generated. For example, a user can employ a UI to establish a query to locate a particular workflow or event record. By way of particular example, a user can establish a query to locate a virtual meeting that took place on a particular date. While a specific example is given, it will be understood that the search criteria can be based upon most any tagged factor or parameter.

At 222, a record or portion of a record can be located. For example, a captured segment of a meeting or other workflow from the virtual workspace or immersive collaborative environment can be located. It will be appreciated that this record can be stored in most any location (e.g., local or remote) or otherwise distributed as desired among various locations. Once located, the record or information can be configured for playback or review by a user at 224. Here, in order to prepare the record for playback, segments of differing types and formats, such as audio and video, can be synchronized so as to provide a seamless playback of the virtual workspace. As well, the playback can be automatically formatted for efficient and/or optimal playback in accordance with user preferences or device characteristics. Similarly, the specification contemplates authentication and other security procedures (e.g., encryption) to be employed to alleviate any unwanted or malicious disclosure of the record.

A determination can be made at 226 to establish if a modification to the record is desired. If so, at 228, a user can create the modification at the appropriate moment in time that corresponds to the record. For example, a user can interject a comment or provide additional information that may not have been originally available among the participants. Accordingly, the record will be modified at 228.

Essentially, if a modification is made at 228, the record can effectively be time-shifted such that the modification appears at the correct time relative to the original record. As well, the record can be marked (or otherwise tagged) so as to provide subsequent viewers easy access to modifications to the original record. Similarly, in other aspects, it can be possible to modify an outcome such as a consensus or decision made based upon newly added (or updated) information. It is to be understood that this outcome modification can be effected automatically based upon MLR or other logic controls. By way of example, in the original environment, users can identify or confirm reasons for a particular outcome. Thus, the system can automatically analyze the modified information (e.g., content analysis, context analysis) and thereafter use the information to calculate a modified outcome.

Still further, upon detecting a modification, the original participants to a meeting or other virtual event can be notified at 230. For example, an email, instant message or other digital communication can be sent to each of the original users to inform them of the change to the original record. It is to be understood that the notification can include information such as, but not limited to, identity of the modifier, substance of the modification, time of the modification, affect on the outcome, etc.

If at 226, a modification is not desired, the record can be tagged with the identity of the user at 232, so as to track those users who have viewed the information. It is to be understood that this tagging is optional. Similarly, it is possible for the record to be tagged with other viewing criteria such as, but not limited to, the number of times a portion of a record was viewed, who viewed it, when it was viewed, etc.

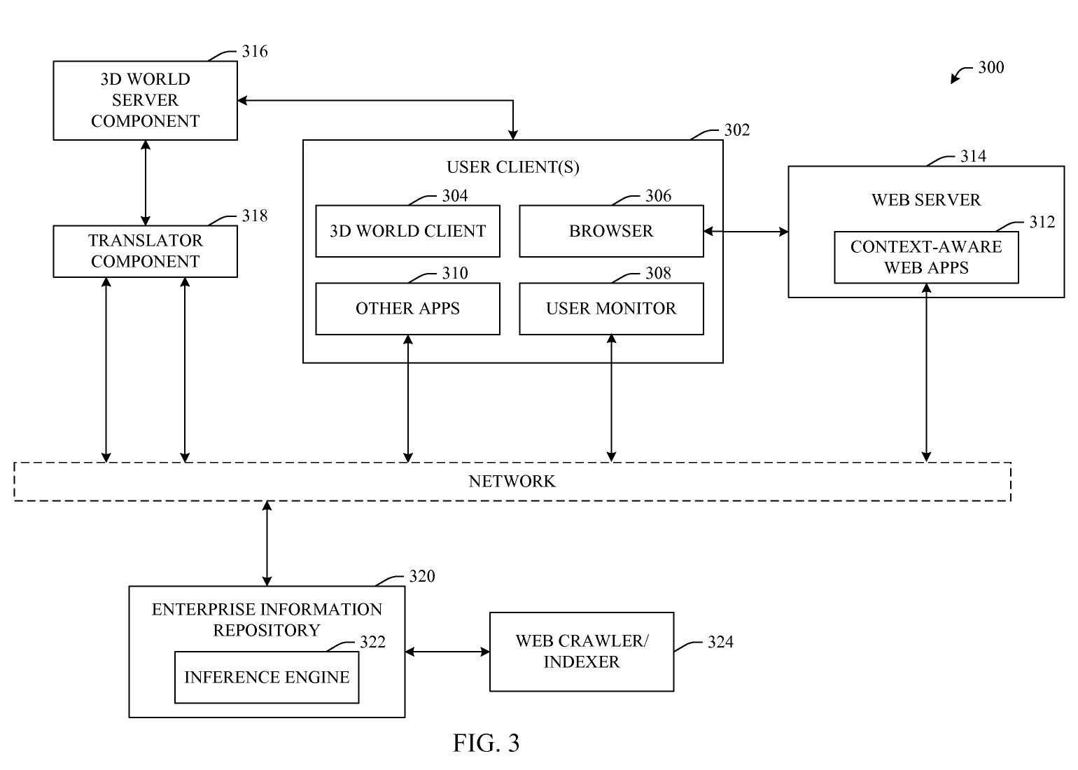

Referring now to FIG. 3, an example block diagram of an immersive collaboration system 300 in accordance with an aspect of the specification is shown. While specific components are illustrated in FIG. 3, it is to be understood that alternative systems can be configured that possess the features, functions and benefits described herein. Thus, system 300 is included to add perspective to the general virtual workspace or immersive collaborative aspects of the specification and is not intended to limit the specification in any manner.

User clients 302 can include a 3D world client 304, a browser 306, a user monitor 308 and other applications 310. In operation, the user monitor 308 can observe contextual factors, including user context, activity context and environmental context. In accordance with a detected context, the 3D world client component 304 can render resources associated with such context. For example, links to other applications 310 can be provided by way of the 3D world client 304. Similarly, the browser 306 can be employed to provide access to context-aware web applications 312 employed within a web server 314.

A server-based 3D world server component 316 and translator component 318 can be provided as needed or desired to provide web based immersive collaborative features, functions and benefits. Still further, in accordance with the context, resources can be accessed by way of an enterprise information repository 320. Additionally, an inference engine 322 and web crawler/indexer 324 can be employed to assist in identification of relevant resources (e.g., data, people, links). For instance, based upon statistical and/or historical analysis and heuristics, the inference engine 322 can establish relevance, or degrees of relevance, of the information. The web crawler/indexer 324 can be employed to identify information and other resources located upon a network, for example, the Internet.

As will be understood, system 300 can not only virtualize a user's desktop but, also their workspace as a whole. Essentially, the system can determine or infer where a user is located, what they are doing, what they are using, and who they are communicating with and automatically render a two-dimensional (2D), two and a half-dimensional (2½ D) or three-dimensional (3D) immersive collaborative display. Generally, the system 300 fuses content, contacts and context in a manner that enables an immersive collaborative environment traditionally reserved for 3D gaming applications.

A single view of a user's environment can be rendered and made available for others to others to join, work within, etc. The collaboration within this environment essentially makes resources (e.g., tools, data, contacts) available based upon a user's context. In operation, an avatar or other suitable representation can be used to symbolize the user within the virtual space.

Within this virtual space, data can be automatically and/or dynamically filtered and provided based upon most any relevant factors including, user activity, user role, user permission, user contacts in close proximity, etc. Similarly, as the system 300 can make this information available to a user in an effort to maximize efficiency, information from all users within a virtual space (e.g., room) can be saved or tagged in association with the room for subsequent use. As well, information can be stitched together so as to provide a cohesive and comprehensive rendition of the activity with a particular room.

One useful embodiment includes an ability to promote cross sharing of information based upon a particular context. As well, the system 300 can intelligently filter information such that a user is only presented with information useful at any moment in time. This information can be displayed via a virtual desktop which enables a view of real world resources within a technologically savvy virtual space. The specification herein, enables actions, events and activities that occur within this virtual workspace environment to be captured and asynchronously modified as described herein.

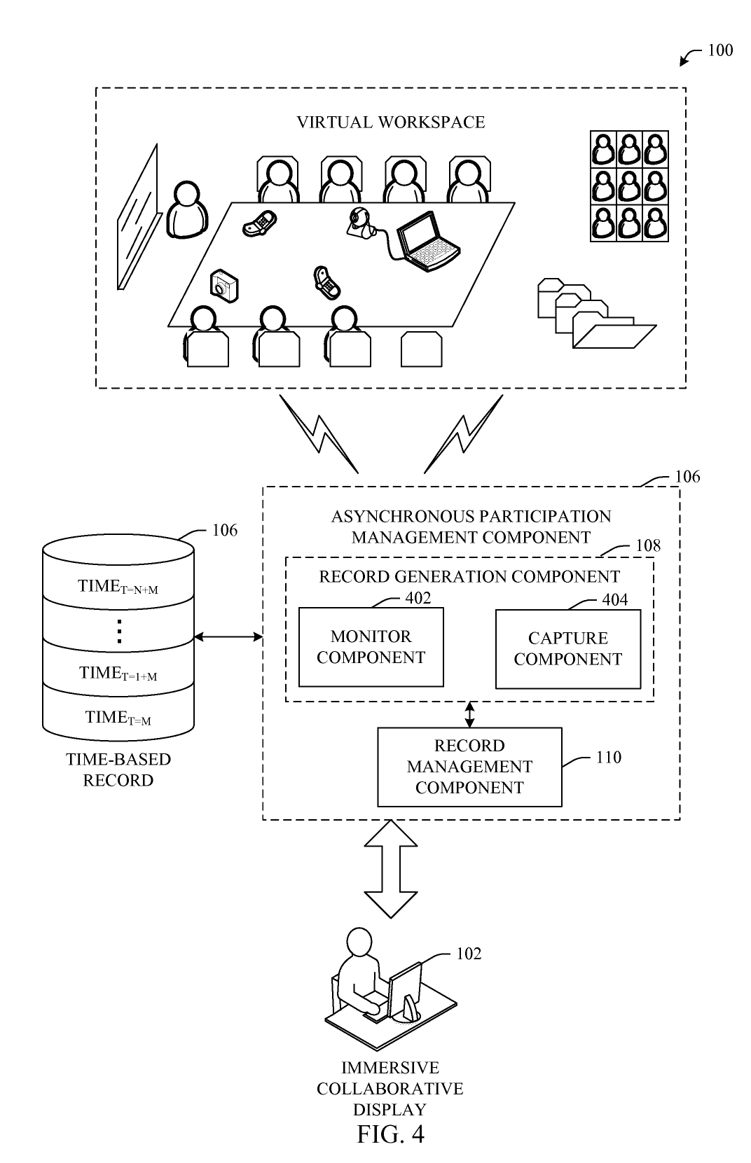

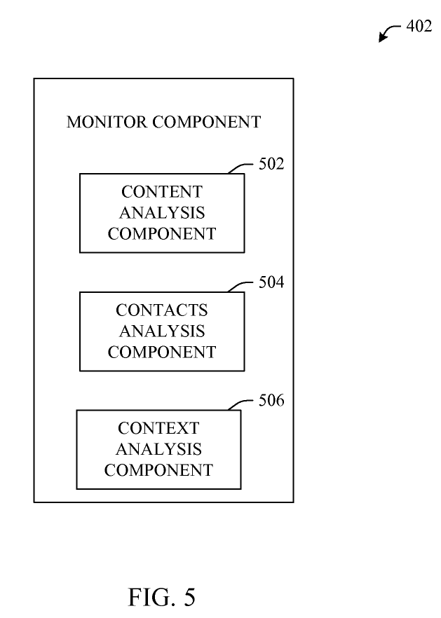

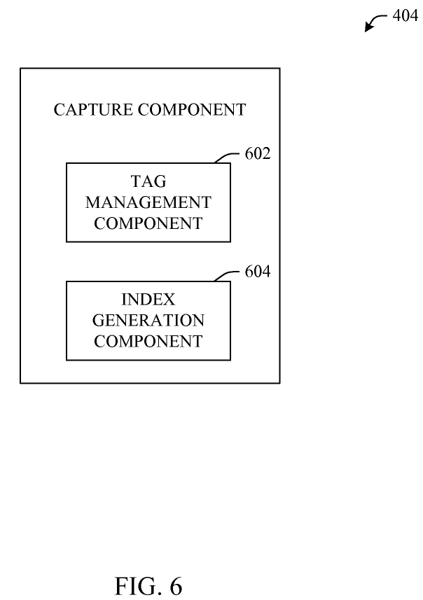

Referring now to FIG. 4, an alternative block diagram of system 100 is shown. As illustrated, the record generation component 108 can include a monitor component 402 and a capture component 404 which, together, facilitate establishment of the time-based record 106 associated with a virtual environment. In operation, the monitor component 402 can be used to analyze content, contacts, context, etc. from the virtual workspace. The capture component 404 can essentially document or memorialize events and/or actions that occur within the immersive collaborative environment or virtual workspace. As described above, the granularity of the monitoring and/or capturing can be predetermined or determined based upon most any factors including, but not limited to, content, presence, context, etc. Each of these sub-components (402, 404) will be described in greater detail with reference to FIGS. 5 and 6 that follow.

Turning now to FIG. 5, a block diagram of an example monitor component 402 in accordance with an aspect of the specification is shown. Generally, monitor component 402 includes a content analysis component 502, a contacts analysis component 504 and a context analysis component 506. Effectively, the monitor component 402 can employ most any sensory mechanism and/or logic to analyze content, contacts and context in accordance with aspects. In addition to providing the content and substance, the analyses can provide information which is used to tag and/or index the record (e.g., time-based record).

In one example, speech and text analyzers can be employed to establish content, contacts and context associated with the virtual workspace. As well, MLR mechanisms can be employed to make inferences on behalf of a user based upon information gleaned and determined from via the monitoring component 402. Once the information is analyzed and segmented by the monitor component 402, the information is further configured for storage within the record.

FIG. 6 illustrates an example capture component 404 that facilitates establishment of the record. Generally, the capture component 404 can include a tag management component 602 and an index generation component 604 that together facilitate establishing a comprehensive, organized and searchable record of events, actions and other information that take place within the virtual environment.

In operation, the tag management component 602 can facilitate user-defined or system automated tagging of information. It will be appreciated that this tagging enables logical storage and retrieval of information from the record (e.g., time-based record). Similarly, the index generation component 604 can be used to generate an index of stored information such that search-ability is enhanced. It is to be understood and appreciated that most any tagging and indexing scheme can be used without departing from the spirit and/or scope of the disclosure and claims appended hereto. As such, these alternative aspects are to be included within the scope of this disclosure and claims appended hereto.

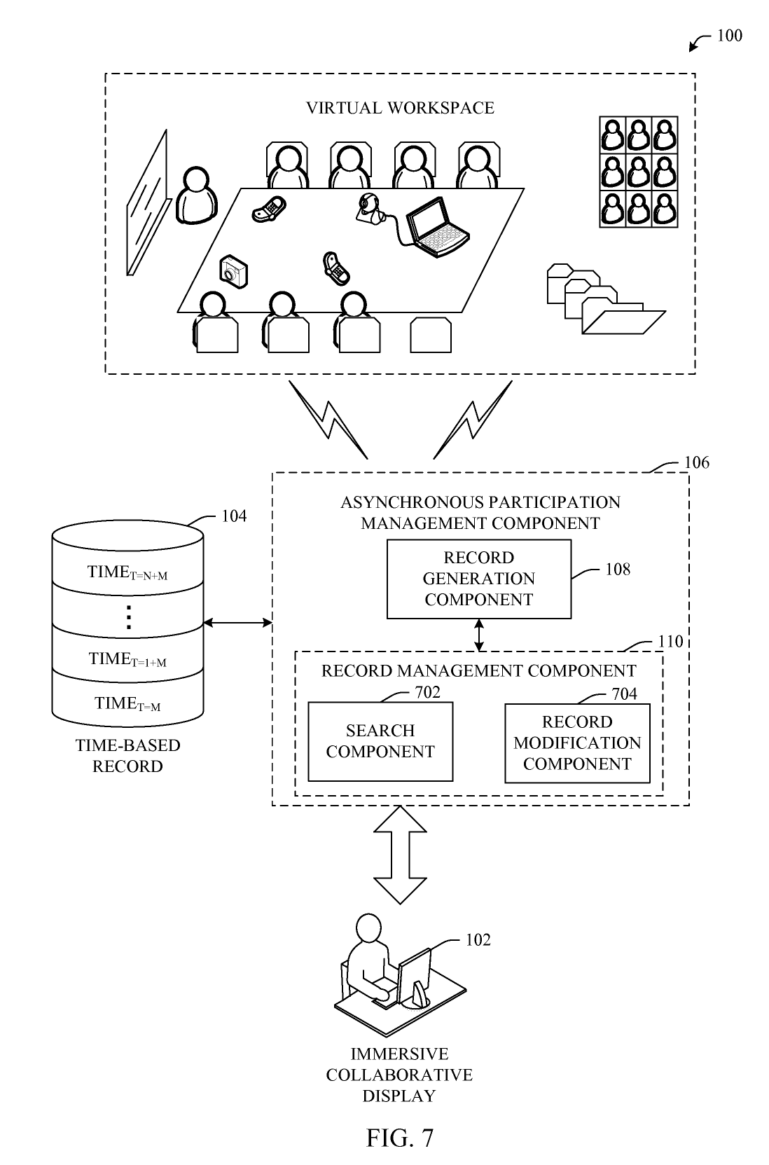

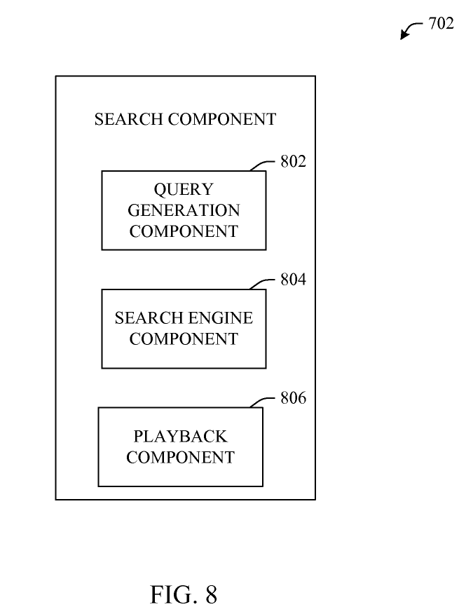

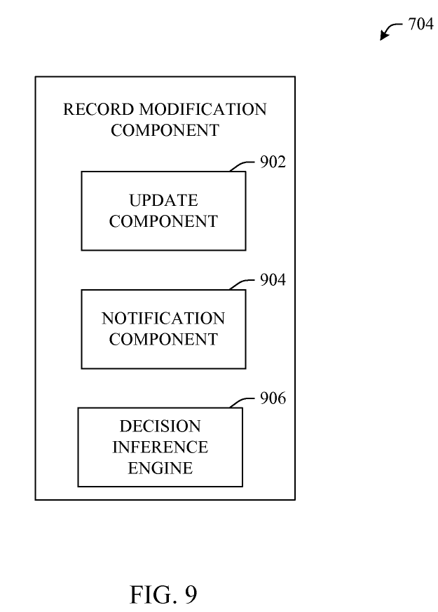

FIG. 7 illustrates yet another alternative example block diagram of system 100. Essentially, FIG. 7 illustrates that record management component 110 can include a search component 702 and a record modification component 704. Together, these sub-components (702, 704) can enable a user to search a time based record (e.g., 104) and thereafter, if desired or appropriate, modify the record (e.g., via the record modification component 704). In operation, as a user modifies the record, or portion thereof, the modified portion is injected into the record (104) in a manner that seemingly shifts time. In other words, the modified portion of the record is chronologically inserted while the remaining portion of the record is shifted to compensate for the time elapsed by the modified portion. Each of these sub-components (702, 704) will be described in greater detail with reference to FIGS. 8 and 9 that follow.

Referring now to FIG. 8, an example block diagram of a search component 702 in accordance with an aspect is shown. Generally, the search component 702 can include a query generation component 802, a search engine component 804 and a playback component 806. Together, these sub-components (802, 804, 806) can be incorporated into or used in conjunction with a UI to enable a user to prompt retrieval and playback of events or activities maintained within a time-based record.

The query component 802 enables a user to establish criteria by which to search a record. For example, criteria can be defined by keywords, either typed or spoken. By way of specific example, a user can establish search criteria to locate an XYZ project meeting held on Sep. 15, 2006. Once the query or search criteria is defined, the system can prompt location and retrieval of the information and event(s) that satisfy the search criteria.

More particularly, a search engine component 804 can be used to locate and retrieve the records, or portions thereof, that correspond to or most closely match the search criteria. As with most search engines, multiple results can be presented to a user along with an indicator of how closely the match is to the search criteria. Accordingly, the user can select a result or group of results.

The playback component 806 can be used to render the matches to the user. In other words, the playback component 806 can format or otherwise configure the information for playback to the user. It is to be understood that this playback can be automatically configured based upon a preference, policy or perspective predefined by a user. Additionally, the playback component 806 can automatically determine a target or display device and/or perspective thereby automatically configuring or formatting the information to optimize playback based upon the target device. For instance, it will be appreciated that the playback will most likely be configured differently if rendered via a smart-phone versus a laptop or desktop computer. In accordance with the disclosure, the playback component 806 can automatically detect device type and capabilities and thereafter configure the information to optimize playback. Additionally, playback can be rendered based upon most any of the participant's views of the workspace, as well as alternative views thereof. For instance, an empty chair can be displayed in the original records which, upon asynchronous viewing, the viewer can see the room from the perspective of this originally empty chair.

Turning now to FIG. 9, a block diagram of a record modification component 704 is shown. As illustrated, the record modification component 704 can generally include an update component 902, a notification component 904 and a decision inference engine 906. Together, these sub-components enable a user to update a record in an asynchronous manner. In other words, a user can inject comments, information, or otherwise change a record during playback.

The update component 902 facilitates a user to be able to change, add or delete information into a previously established record. As described supra, once the information (or record) is modified, the record can be adjusted by effectively time-shifting information and events that follow the modified sections. Effectively, the record is reconfigured to establish a seamless rendition of the events and information in the record.

Additionally, if desired, the modified information can be tagged or otherwise identified such that a review of the record could easily identify the original information from the modified information. For example, in one embodiment, on-screen effects such as text, symbols, effect enhancements, etc. can be employed to distinguish the modified information from the original information.

The notification component 904 can be used to send a notification to original participants associated with the record. Here, the notification can inform the original participants that the record has been viewed and/or altered. In a particular example, the notification can identify the user who viewed and/or modified the record. Additionally, the notification can identify which portion and/or portions of the record that have been modified. Thus, if desired, original participants can access and view the modified record in a seamlessly chronological format.

Still further, as described above, a decision inference engine 906 can be employed to automatically revise the outcome, consensus or decision made during the original meeting. This revision can be based upon the newly added information as appropriate. Most any MLR mechanisms can be employed automatically to revise the outcome based upon the modified (or added) information. Essentially, the decision inference engine 906 can consider the reasoning of the original outcome, consensus or decision and recalculate the same based upon the new information. Following is a discussion of example MLR mechanisms that can be employed in connection with the decision inference engine 906, as well as other inferences described above.

As described supra, the specification suggests inference in lieu of (or in addition to) explicit decision making. Accordingly, the systems described herein can employ MLR components which facilitate automating one or more features in accordance with the subject specification. The subject specification (e.g., in connection with decision inference/modification) can employ various MLR-based schemes for carrying out various aspects thereof. For example, a process for determining when to modify an outcome based upon modified information, how best to tag/index information, how best to render information, when/if to render a notification of modification, optimal modalities of notification, etc. can be facilitated via an automatic classifier system and process.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject specification can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining if/how to revise an outcome, if/how to tag/index information, how to render information, etc.

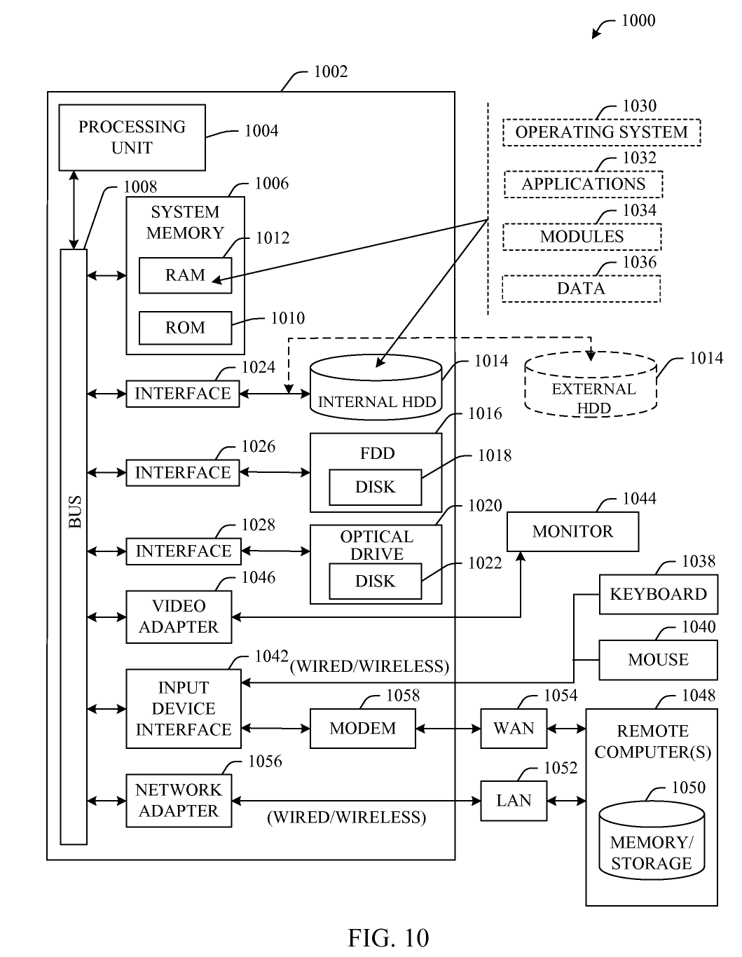

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, DVD or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). It is to be understood that other storage devices, for example, flash memory and flash drives, can be employed in alternative aspects. The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet, for example, from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

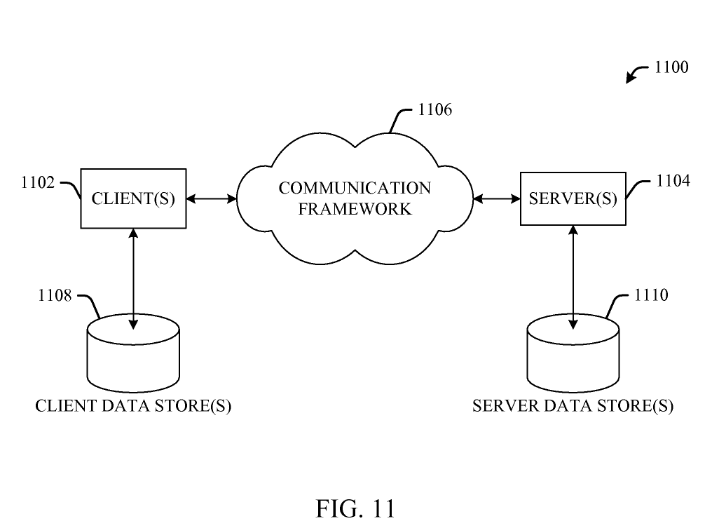

Referring now to FIG. 11, there is illustrated a schematic block diagram of an exemplary computing environment 1100 in accordance with the subject specification. The system 1100 includes one or more client(s) 1102. The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware and/or software (e.g., threads, processes, computing devices). The servers 1104 can house threads to perform transformations by employing the specification, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the specification. It is, of course, not possible to describe every conceivable combination of components or methodologies for purposes of describing the subject specification, but one of ordinary skill in the art may recognize that many further combinations and permutations of the specification are possible. Accordingly, the specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a record generation component that establishes a time-based historical record as a function of a virtual workspace; and
a record management component that enables asynchronous manipulation of a subset of the time-based historical record.

2. The system of claim 1, wherein the virtual workspace is a spatial representation of a workflow based upon a business process.

3. The system of claim 1, wherein the record generation component comprises one or more monitor components that dynamically monitor a plurality of events within the virtual workspace.

4. The system of claim 3, further comprising a content analysis component that evaluates content of the virtual workspace, wherein the time-based historical record is established based at least in part upon the content.

5. The system of claim 3, further comprising a contacts analysis component that identifies a plurality of representations within the virtual workspace, wherein the time-based historical record is established based at least in part upon a subset of the contacts.

6. The system of claim 3, further comprising a context analysis component that establishes a plurality of circumstantial factors related to the virtual workspace, wherein the time-based historical record is based at least in part upon a subset of the circumstantial factors.

7. The system of claim 3, further comprising a capture component that chronologically records the plurality of events, wherein the captured plurality of events comprises a portion of the time-based historical record.

8. The system of claim 7, further comprising a tag management component that applies identification to each of the plurality of events.

9. The system of claim 8, further comprising an index generation component that establishes an index of each of the plurality of events within the time-based historical record.

10. The system of claim 1, further comprising a search component that facilitates location of an event within the time-based historical record.

11. The system of claim 10, further comprising a query generation component that facilitates generation of a search query, wherein the search query is based upon at least one of content, contacts or context.

12. The system of claim 11, further comprising a search engine that employs the search query to identify the subset of the time-based record.

13. The system of claim 12, further comprising a playback component that renders the subset of the time-based record to a user.

14. The system of claim 1, further comprising a record modification component that facilitates alteration of the time-based historical record.

15. The system of claim 14, further comprising:
an update component that facilitates asynchronous modification of the time-based historical record, wherein the modification prompts a chronological shift in the time-based historical record; and
a notification component that alerts a group of participants bound to the virtual workspace.

16. The system of claim 15, further comprising a decision inference engine that dynamically modifies a result of the time-based historical record based at least in part upon the input or the modification.

17. A computer-implemented method for asynchronously modifying a time-based historical record, comprising:
accessing a portion of the time-based historical record, wherein the time-based historical record represents a chronology of events from a virtual workspace;
asynchronously modifying the portion of the time-based historical record;
notifying a plurality of participants bound to the virtual workspace, wherein the notification summarizes the modified portion of the time-based historical record;
shifting portions of the time-based historical record based upon the modified portion; and
inserting the modified portion into the time-based historical record.

18. The computer-implemented method of claim 17, further comprising
monitoring a plurality of events within the virtual workspace; and
establishing the time-based historical record based upon the plurality of events.

19. The computer-implemented method of claim 18, further comprising capturing the plurality of events together with at least one of content, contacts or contextual factors associated with each of the plurality of events.

20. The computer-implemented method of claim 18, further comprising analyzing at least one of content, contacts or context associated with the plurality of events.

21. The computer-implemented method of claim 20, further comprising tagging each of the plurality of events based at least in part upon the content, contacts or context associated therewith.

22. The computer-implemented method of claim 21, further comprising presenting the portion of the time-based historical record to facilitate asynchronous modification.

23. The computer-implemented method of claim 18, further comprising inferring an alternative decision based upon the modified portion.

24. A computer-executable system, comprising:
means for generating a time-based record of events related to a virtual workspace; and
means for asynchronously modifying a portion of the record.

25. The computer-executable system of claim 24, further comprising means for inferring an alternative decision point based at least in part upon the modified portion of the time-based record.
